(19) United States
(12) Patent Application Publication
(10) Pub. No.: US 2018/0282086 A1
(43) Pub. Date: Oct. 4, 2018

(54) UNIVERSAL PART GRIPPER WITH CONFORMABLE TUBE GRIPPERS

(71) Applicant: XEROX CORPORATION, Norwalk, CT (US)

(72) Inventors: Linn C. Hoover, Webster, NY (US); PAUL M. FROMM, Rochester, NY (US); ERWIN RUIZ, Rochester, NY (US); JEFFREY J. BRADWAY, Rochester, NY (US)

(21) Appl. No.: 15/477,126

(22) Filed: Apr. 3, 2017

(51) Int. Cl. B65H 3/08; B29C 67/00; B65C 9/18

(52) U.S. Cl. CPC B65H 3/0816; B65H 3/0883; B29C 67/0092; B65C 9/1884; B29C 67/0085

(57) ABSTRACT

A holder plate containing sliding spring-loaded shutter plates with conformable elastic tubes filled with granular material attached to each shutter plate. A part is placed between the shutter plates that close and compress the tubes against the part. The tubes conform to the part surface. Vacuum is applied to each tube. Atmospheric air pressure compresses the elastic tubes and compacts the material inside the by forming a rigid gripper on each side of the part.

### CROSS REFERENCE TO RELATED APPLICATIONS

Cross-referenced is commonly assigned U.S. application Ser. No. ______, filed Ser, No. ______, and entitled APPARATUS FOR HOLDING DURING THREE-DIMENSIONAL (3-D) OBJECTS DURING PRINTING THEREON by Jeffrey J. Bradway et al (Attorney No. 20161211US01); U.S. application Ser. No. ______, filed Ser. No. ______, and entitled VACUUM TUBE OBJECT CLAMPING ARRAY WITH CONFORMABLE PADS by Timothy P. Foley et al (Attorney No. 20161136US01); U.S. Application Serial No. ______, filed Ser. No. ______, and entitled SPRING LOADED SUCTION CUP ARRAY GRIPPER by Paul M. Fromm et al (Attorney No. 20161213US01); U.S. application Ser. No. ______, filed Ser. No. ______, and entitled UNIVERSAL OBJECT HOLDER FOR 3-D PRINTING USING A CONFORMABLE GRIPPER BALL by Erwin Ruiz et al (Attorney No. 20161214US01); U.S. application Ser. No. ______, filed Ser. No. ______, and entitled UNIVERSAL PART GRIPPER USING 3-D PRINTED MOUNTING PLATE by Linn C. Hoover et al (Attorney No. 20161217US01); U.S. application Ser. No. ______, filed Ser. No. ______, and entitled APPARATUS FOR GENERAL OBJECT HOLDING DURING PRINTING USING MULTIPLE CONFORMABLE BALLS by Jeffrey J. Bradway et al (Attorney No. 20161227US01); U.S. application Ser. No. ______, filed Ser. No. ______, and entitled AIR PRESSURE LOADED MEMBRANE AND PIN ARRAY GRIPPER by Paul M. Fromm et al (Attorney No. 20161266US01); U.S. application Ser. No. ______, filed Ser. No. ______, and entitled APPARATUS FOR REPEATABLE STAGING AND HOLDING OBJECTS IN A DIRECT TO OBJECT PRINTER USING AN ARRAY OF PINS by Jeffrey J. Bradway et al (Attorney No. 20170042US01); and U.S. application Ser. No. ______, filed ______, and entitled SPRING LOADED IRIS MECHANISM STACK GRIPPER by Paul M. Fromm et al (Attorney No. 20161222US01); all of which are included in their entirety herein by reference.

### TECHNICAL FIELD

This disclosure relates generally to printing on three-dimensional (3-D) objects, and more particularly, to an apparatus adapted for general object holding while printing on such objects in a non-production environment.

### BACKGROUND

Commercial article printing typically occurs during the production of the article. For example, ball skins are printed with patterns or logos prior to the ball being completed and inflated. Consequently, a non-production establishment, such as a distribution site, which customizes products, for example, in region in which potential product customers support multiple professional or collegiate teams, needs to keep an inventory of products bearing the logos of the various teams. Ordering the correct number of products for each different logo to maintain the inventory can be problematic.

One way to address these issues in non-production outlets would be to keep unprinted versions of the products, and print the patterns or logos on them at the distribution site. Adapting known printing techniques, such as two-dimensional (2-D) media printing technology, to apply image content onto three-dimensional objects would be difficult. Since the surfaces to be printed must be presented to the print heads as relatively flat, two-dimensional surfaces, the objects have to be maneuvered carefully to present portions of the articles as parallel planes to the print heads.

One Direct-to-Object printing system that accomplishes this is disclosed in copending and commonly assigned U.S. patent application Ser. No. 15/163,880, filed on May 25, 2016, and entitled SYSTEM FOR PRINTING ON THREE-DIMENSIONAL (3D) OBJECTS by Wayne A. Buchar et al (Attorney No. 20150747US01). This printing system includes a plurality of print heads arranged in a 2-D array, each printhead being configured to eject marking material, a support member positioned to be parallel to a plane formed by the 2-D array of print heads, a member movably mounted to the support member, an actuator operatively connected to the movably mounted member to enable the actuator to move the moveably mounted member along the support member, an object holder configured to mount to the movably mounted member to enable the object holder to pass the array of print heads as the moveably mounted member moves along the support member, and a controller operatively connected to the plurality of print heads and the actuator, the controller being configured to operate the actuator to move the object holder past the array of print heads and to operate the plurality of print heads to eject marking material onto objects held by the object holder as the object holder passes the array of print heads. This application is included herein by reference to the extent necessary to the practice the present disclosure and in its entirety.

A problem with this approach is that it requires a unique part gripper for each part that is to be printed. Part grippers are currently machined metal brackets with dedicated locating and fastening features machined into each gripper. Customer productivity is impacted using these part grippers due to the time required to design and make a unique mounting plate for each part and the costs associated with each part gripper design. A standalone spherical shaped conformable gripper filled with granular material is shown in U.S. Pat. No. 8,882,165 used to pick and place objects.

### SUMMARY

In answer to these shortcomings, disclosed is a universal gripper for many types of objects. The universal gripper includes a holder plate containing sliding spring loaded shutter plates with conformable elastic tubes filled with granular material attached to each shutter. An object is placed between the shutter plates that close and compress the tubes against the object. The tubes conform to the object surface. Vacuum is applied to each tube. Atmospheric air pressure compresses the elastic tubes and compacts the material inside the tubes forming a rigid gripper on each side of the object.

### BRIEF DESCRIPTION OF THE DRAWINGS

The foregoing aspects and other features of a printing system that prints images on 3-D objects are explained in the following description, taken in connection with the accompanying drawings.

FIG. 1 illustrates an exemplary universal gripper that includes gripper tubes for stabilizing a gripped object for printing thereon;

FIG. 2 a cross-sectional view of a flexible gripper tube used in the exemplary universal 3-D object holder in FIG. 1;

FIGS. 3A and 3B are a plan views of the universal gripper of FIG. 1 showing an object in the process of being gripped in FIG. 3A and gripped in FIG. 3B; and

FIG. 4 depicts the universal 3-D object holder in FIG. 1 gripping an object;

### DETAILED DESCRIPTION

For a general understanding of the present embodiments, reference is made to the drawings. In the drawings, like reference numerals have been used throughout to designate like elements.

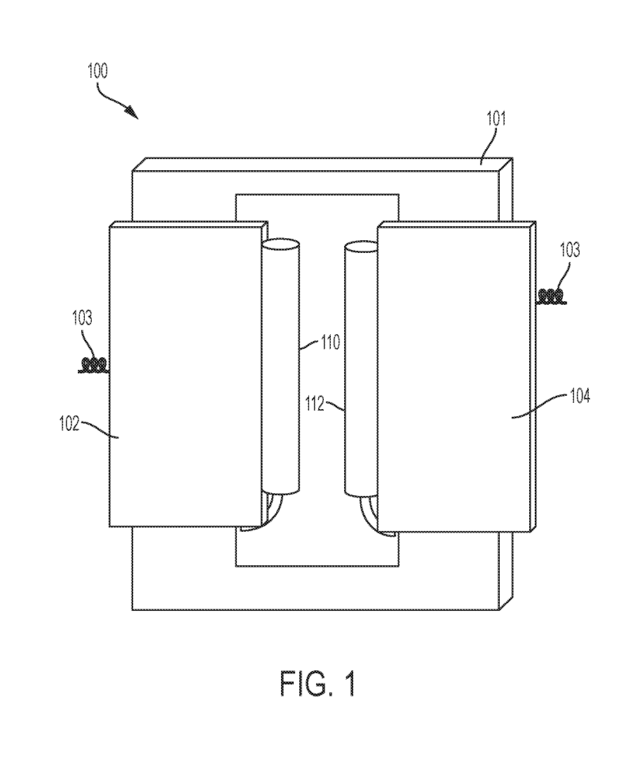

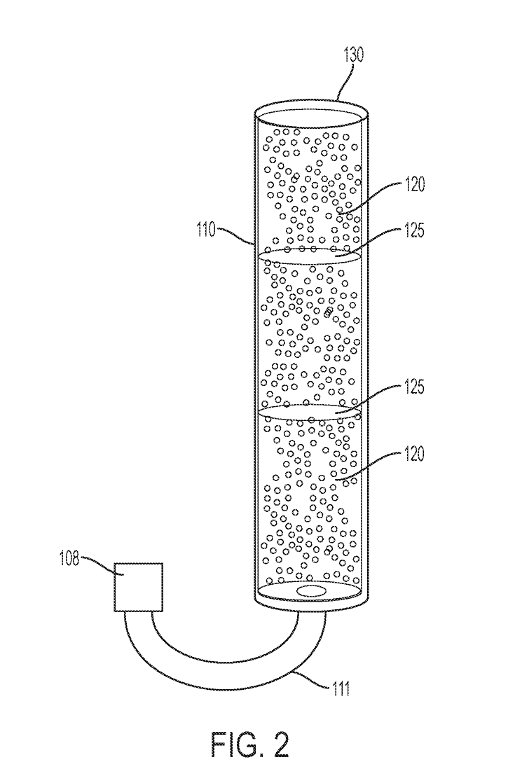

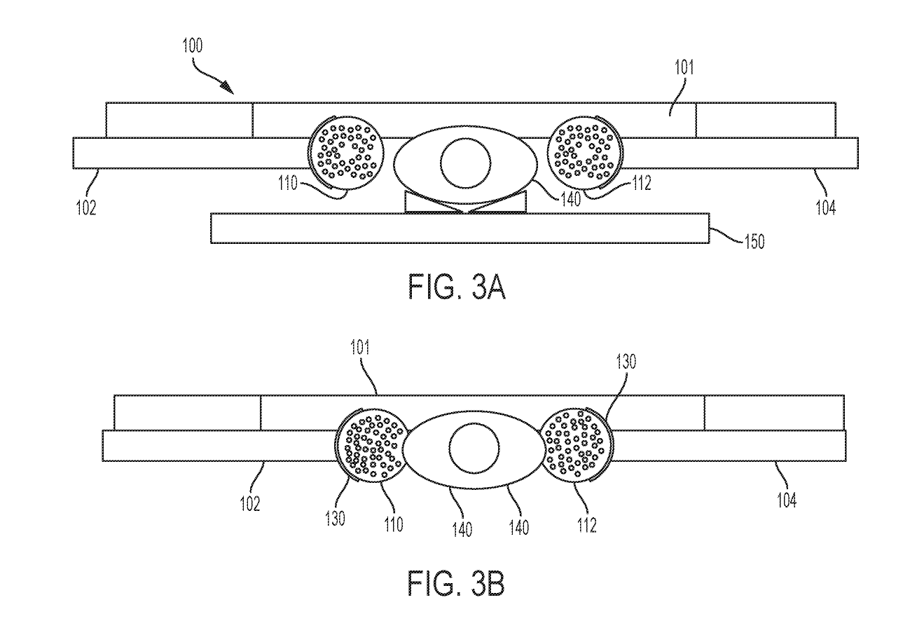

Turning now to the present disclosure, a generic or universal object gripper 100 in FIG. 1 includes a mounting plate 101 for holding a part or object that is to be printed upon by a 3-D printer. Two shutter plates 102 and 104 are spring-loaded at 103 and positioned adjacent support plate 101 and are connected to conventional mechanical mechanisms, such as, linkage or rack and pinion gears that are configured to open and close shutters 102 and 104 by sliding them simultaneously towards or away from each other. Opening of the shutter plates expose a large area for insertion of an object. Each shutter plate 102 and 104 includes flexible tubes 110 and 112, respectfully, supported by a semi-circular mounting bracket 130 attached to an inside edge as shown in FIG. 3. Tubes 110 and 112 are comprised of flexible non-permeable material shell 122 and are filled with irregular shaped granular material 120, such as, plastic. Flexible permeable dividers 125 as shown in FIG. 2 are positioned within tube 110 to keep the granular material 120 evenly spread throughout the tube when it is in a vertical position. Vacuum or pressurized air is applied to each tube though hose 111 attached to a source of vacuum or air pressure 108. Both tube 110 and 112 are connected to source 108. The previously mentioned irregular shape of beads 120 enable the beads to lock together when vacuum is applied to the tube which collapses the shell 122 and compacts the beads into a semi-rigid shape around an object to steadily hold the object for further processing.

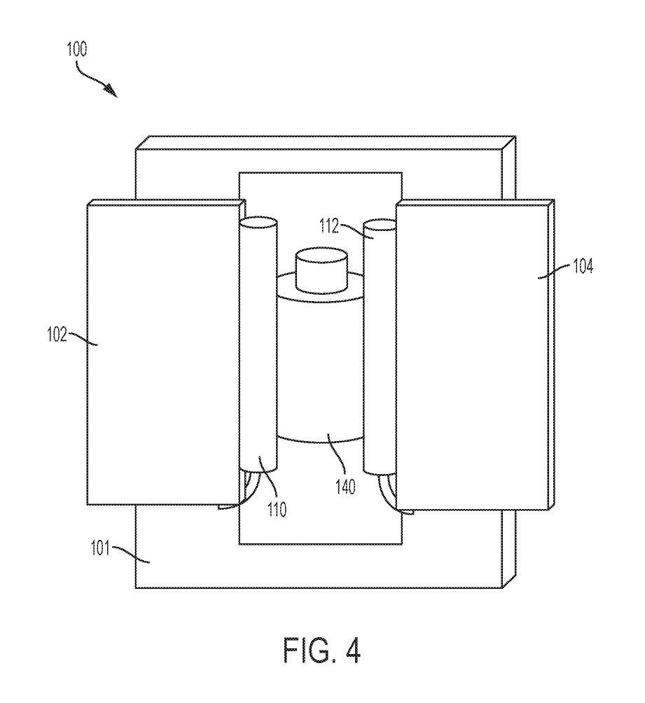

In practice, as shown in FIGS. 3A, 3B and FIG. 4, object 140 to be printed upon is placed into a beveled part of a locating fixture 150. Locating fixture 150 orients and spaces the object relative to the print heads of a 3-D printer. Gripper plate 101 is placed over the locating fixture with the object in between shutter plates 102 and 104 which are closed on the object so that tubes 110 and 112 are compressed against the object. The closure force on the shutter plates presses the tubes and granular filler to conform around the object surface. The semi-circular mounting bracket 130 support the back side of the tubes and prevents the tubes from being deformed around the shutter plate edge. Vacuum is applied to each tube from source 108 causing each tube to compress under atmospheric air pressure and compact the granular material inside forming the semi-rigid gripper of FIG. 4. The universal holder 100 is then moved past the print heads of a 3-D printer. Once printing on object140 has taken place, the operator grips the object while the shutter plated slide open. Vacuum is then removed from the tubes and the grippers return to their compliant state. A positive pressure can be applied to each tube to restore their round tube shape.

It should now be understood that a universal part holder that can be used for holding objects in Direct-to-Object printing has been shown that includes conformable elastic tubes filled with granular particles (e.g., plastic) that go from a conformable to rigid state when vacuum is applied. The tubes are held against a part using spring-loaded plates, so that as the vacuum is applied the tubes will stay in contact with the part at a desired force. Inside the tubes are permeable dividers that keep the granular particles evenly spread throughout the tubes. The backside of each tube is held in a semi-circular channel in the spring-loaded plates to make sure that tubes do not squeeze out over the edges of the plate. Before gripping the part, it is placed in a locating fixture that orients and spaces the part with respect to machine print heads that will print onto the part. When printing is complete, the operator grips the part while the shutter plates slide open. Vacuum is removed from the tubes and the grippers return to the compliant state.

It will be appreciated that variations of the above-disclosed apparatus and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A universal object holder, comprising:
a member having an open area therein for placement of object to be printed upon;
slidable shutter plates configured to open to allow unimpeded access to said open area by an object and subsequently close against said object once it is in place;
gripper tubes filled with a conformable material attached to an inside edge of each slidable shutter plate; and
a vacuum pressure for applying vacuum pressure to said gripper tubes such that they collapse around portions of said object and secure the object in place.

2. The universal object holder of claim 1, wherein said universal object holder is incorporated into a printer that prints on 3-D objects.

3. The universal object holder of claim 1, wherein said conformable material in said gripper tubes includes granular filler therein.

4. The universal object holder of claim 3, wherein said granular filler is beads.

5. The universal object holder of claim 4, wherein said beads are irregular in shapes that enables said beads in locking together when vacuum is applied to said tubes.

6. The universal object holder of claim 5, wherein said tubes include dividers to keep said granular material evenly spread throughout said tubes.

7. The universal object holder of claim 6, wherein said dividers are permeable.

8. The universal object holder of claim 6, wherein said dividers are flexible.

9. The universal object holder of claim 8, including semi-circular support members that support a backside of said of said tubes to prevent said tubes from being deformed arounds edges of said shutter plates.

10. The universal object holder of claim 9, wherein said slidable shutter plates are spring loaded.

11. An apparatus for holding various object shapes in a Direct-to-Object printer, comprising:
conformable elastic tubes, said conformable elastic tubes being filled with granular particles that go from a conformable to rigid state when vacuum is applied;
a vacuum source adapted to apply vacuum flow within said conformable elastic tubes;
a rectangular object mounting member; said rectangular object mounting member including an opening therein for the placement of an object that is to be printed upon;
a pair of spring-loaded shutter plates configured for movement towards and away from each other simultaneously so that as said vacuum is applied said tubes stay in contact with said object at a predetermined force, and wherein said conformable elastic tubes are connected to inside edges of said spring-loaded shutter plates; and
wherein backsides of said conformable elastic tubes are held in a semi-circular channel in said shutter plates to ensure that said tubes do not squeeze out over the edges of said spring-loaded shutter plates.

12. The apparatus of claim 11, wherein said granular particles are plastic.

13. The apparatus of claim 12, wherein said granular particles are irregular in shape and spread evenly throughout said conformable elastic tubes.

14. The apparatus of claim 13, wherein said conformable elastic tubes includes dividers adapted to keep said granular particles evenly spaced throughout said conformable elastic tubes when said conformable d elastic tubes are in a vertical position.

15. The apparatus of claim 14, wherein said dividers are flexible.

16. The apparatus of claim 15, wherein said dividers are permeable.

17. An object holding device, comprising:
conformable elastic tubes, said conformable elastic tubes being filled with granular particles that go from a conformable to rigid state when air pressure is applied;
a source adapted to apply air pressure flow within said conformable elastic tubes;
an object mounting member; said object mounting member including an opening therein for the placement of an object to receive print;
a pair of spring-loaded shutter plates configured for movement towards and away from each other simultaneously so that as said vacuum is applied said tubes stay in contact said object at a predetermined force, and wherein said conformable elastic tubes are connected to inside edges of said spring-loaded shutter plates; and
wherein back sides of said tubes are held in a semi-circular channel in said shutter plates to ensure that said conformable elastic tubes do not squeeze out over the edges of said spring-loaded shutter plates.

18. The object holding device of claim 17, wherein said granular particles are plastic.

19. The object holding device of claim 17, wherein said granular particles are irregular in shape and spread evenly throughout said conformable elastic tubes.

20. The object holding device of claim 17, wherein said conformable elastic tubes includes dividers adapted to keep said granular particles evenly spaced throughout said conformable elastic tubes when said conformable d elastic tubes are in a vertical position.
